(19) United States
(12) Patent Application Publication
(10) Pub. No.: US 2007/0236097 A1
(43) Pub. Date: Oct. 11, 2007

(54) Fuel pump

(75) Inventor: Tadashi Hazama, Chita-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/727,247

(22) Filed: Mar. 26, 2007

(30) Foreign Application Priority Data
Apr. 6, 2006 (JP) 2006-104990

(51) Int. Cl. H01R 39/38; H01R 39/36

(52) U.S. Cl. 310/242; 310/249

(57) ABSTRACT

A fuel pump includes a pump unit, a motor unit, a brush, and a pigtail. The pump unit boosts a pressure of fuel that is drawn into the fuel pump. The motor unit has an armature that rotates and a commutator that rectifies electric current, which is supplied to the armature. The pump unit is driven by rotating of the armature. The fuel, the pressure of which is boosted by the pump unit, passes through the motor unit. The brush contacts the commutator. The pigtail is connected to the brush and supplies electricity to the armature via the brush. The pigtail is made from a copper alloy, which includes at least one of a corrosion-resistant metal that has higher sulfide formation energy than copper and a corrosion-resistant metal that has higher oxide formation energy than copper.

### CROSS REFERENCE TO RELATED APPLICATION

This application is based on and incorporates herein by reference Japanese Patent Application No. 2006-104990 filed on Apr. 6, 2006.

### BACKGROUND OF THE INVENTION

1. Field of the Invention

The present invention relates to a fuel pump.

2. Description of Related Art

A conventional fuel pump has a pump unit and a motor unit. The pump unit boosts a pressure of fuel that is drawn. The motor unit includes an armature and 3 commutator, and drives the pump unit. Fuel flows through inside of a casing of the motor unit (e.g., JP56-66446A corresponding to GB2064228A, JP9-154261A, JP2001-186708A, and JP2002-218712A). A brush contacts the commutator. The brush is connected to a terminal via a pigtail. Electricity that is supplied to the terminal is supplied to the armature after passing through the pigtail, the brush, and the commutator in this order.

An end of the pigtail is inserted in an attachment hole formed on the brush. The attachment hole is filled with a metal powder. The metal powder serves as a holding fixture that electrically connects the pigtail and the brush. The brush is pressed against the commutator. Deformation of the pigtail is caused by movement of the brush in the pressing direction. Accordingly, flexibility whereby the pigtail is deformed following the movement of the brush is obtained, generally by employing a copper wire for a pigtail material.

However, when sulfur or oxidative components are included in fuel, the copper wire of the pigtail is corroded by those components, thereby thinning down a wire diameter of the copper wire. Consequently, the copper wire can be broken due to vehicle vibration, for example. On the other hand, as in JP2001-186708A, corrosion proof of the pigtail is increased by employing an iron-based metal or carbon fiber for the pigtail material instead of the copper wire. Nevertheless, the above flexibility, which is necessary for the pigtail, is reduced.

Although a copper powder is generally employed for the metal powder that serves as the holding fixture, when the sulfur or oxidative components are included in fuel, the copper powder is corroded by those components, thereby causing a possibility of a bad electrical connection between the pigtail and the brush. To counter this, as in JP2002-218712A, by employing a tin or gold power instead of the copper powder, the corrosion proof is increased. However, employment of the tin power causes increase in electrical resistance, whereas employment of the gold power causes high cost.

### SUMMARY OF THE INVENTION

The present invention addresses the above disadvantages. Thus, it is an objective of the present invention to provide a fuel pump having a pigtail that realizes its flexibility as well as increase in corrosion proof. Furthermore, it is another objective to provide a fuel pump having a holding fixture that realizes the increase in the corrosion proof with electrical resistance decreased and high cost limited.

To achieve the objective of the present invention, there is provided a fuel pump including a pump unit, a motor unit, a brush, and a pigtail. The pump unit if for boosting a pressure of fuel that is drawn into the fuel pump. The motor unit has an armature that rotates and a commutator that rectifies electric current, which is supplied to the armature. The pump unit is driven by rotating of the armature. The fuel, the pressure of which is boosted by the pump unit, passes through the motor unit. The brush contacts the commutator. The pigtail is connected to the brush and supplies electricity to the armature via the brush. The pigtail is made from a copper alloy, which includes at least one of a corrosion-resistant metal that has higher sulfide formation energy than copper and a corrosion-resistant metal that has higher oxide formation energy than copper.

To achieve the objective of the present invention, there is also provided a fuel pump including a pump unit, a motor unit, a brush, a pigtail, and a holding fixture. The pump unit is for boosting a pressure of fuel that is drawn into the fuel pump. The motor unit has an armature that rotates and a commutator that rectifies electric current, which is supplied to the armature. The pump unit is driven by rotating of the armature. The fuel, the pressure of which is boosted by the pump unit, passes through the motor unit. The brush contacts the commutator and has an attachment hole. The pigtail is inserted in the attachment hole and is connected to the brush to supply electricity to the armature via the brush. The holding fixture electrically connects the pigtail and the brush and is made from a copper alloy powder, which includes at least one of a corrosion-resistant metal that has higher sulfide formation energy than copper and a corrosion-resistant metal that has higher oxide formation energy than copper. The attachment hole is filled with the holding fixture.

### BRIEF DESCRIPTION OF THE DRAWINGS

The invention, together with additional objectives, features and advantages thereof, will be best understood from the following description, the appended claims and the accompanying drawings in which:

FIG. 1 is a front view showing a brush, a pigtail and a holding fixture according to an embodiment of the present invention;

FIG. 2 is a cross-sectional view of a fuel pump according to the embodiment;

FIG. 3 is a graph showing a relationship between an added corrosion-resistant metal amount and a rate of decrease in diameter according to the embodiment; and

FIG. 4 is a graph showing a relationship between the added corrosion-resistant metal amount and a performance deterioration rate according to the embodiment.

### DETAILED DESCRIPTION OF THE INVENTION

An embodiment of the present invention will be described below with reference to the accompanying drawings.

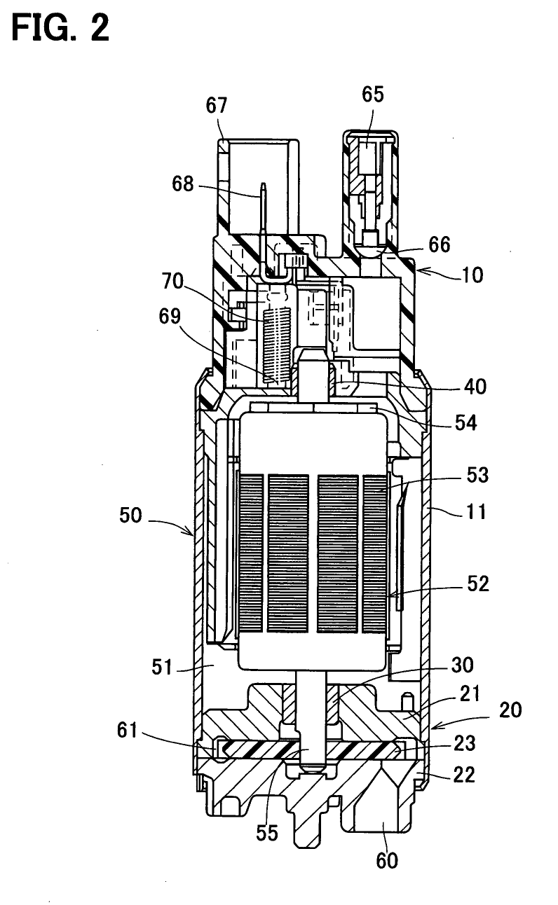

A fuel pump 10 shown in FIG. 2 is received by, for example, a fuel tank of a two-wheel or four-wheel vehicle (not shown), and supplies fuel that is drawn from the fuel tank to an engine side.

The fuel pump 10 includes a pump unit 20 and a motor unit 50, which is an electromagnetic drive unit that drives the pump unit 20. The motor unit 50 is a direct-current motor having a brush. A permanent magnet is disposed annularly in a cylindrical housing 11, and an armature 52 is provided concentrically with the permanent magnet on an inner circumferential side of the permanent magnet.

The pump unit 20 includes a casing main body 21, a casing cover 22, an impeller 23, and the like. The casing main body 21 and the casing cover 22 constitute a flow passage member, in which the impeller 23 as a rotating member is rotatably received. The impeller 23 has blades at its periphery along its entire circumference, and blade grooves formed therebetween. The casing main body 21 and the casing cover 22 are formed by, for example, die-casting of aluminum. A bearings member 30 is fitted into a central part of the casing main body 21. One end of a rotational axis 55 of the armature 52 is rotatably supported by the bearings member 30. The other end of the rotational axis 55 is rotatably supported by a bearings member 40.

As shown in FIG. 2, a fuel inlet 60 is formed in the casing cover 22. When the impeller 23 rotates, fuel in the fuel tank (not shown) is drawn into a pump flow passage 61 from the fuel inlet 60. A pressure of the fuel drawn into the pump flow passage 61 is boosted by the rotating of the impeller 23. Then, the fuel is discharged into a combustion chamber 51 of the motor unit 50 from a fuel outlet formed on the casing main body 21.

The armature 52 is rotatably received by the motor unit 50. A coil is wound on the outer circumference of a core 53. A commutator 54 is formed in a disk-shaped manner, and is located on top of the armature 52. Electricity is supplied to the coil by a power source (not shown) through a terminal 68, which is embedded in a connector housing 67, a brush 69, and the commutator 54. The brush 69 is pressed against the commutator 54 by a coil spring 70 as an elastic member. As shown in FIG. 2, the brush 69 is disposed in an axial direction of the rotational axis 55, and is pressed in the axial direction. Alternatively, the brush 69 may be disposed in a radial direction of the rotational axis 55, and may be pressed in the radial direction.

When the armature 52 rotates using the electricity supplied, the impeller 23 rotates together with the rotational axis 55 of the armature 52. When the impeller 23 rotates, fuel is drawn from the fuel inlet 60 into the pump flow passage 61, and receiving kinetic energy from each blade of the impeller 23, the fuel is discharged from the pump flow passage 61 into the combustion chamber 51. The fuel discharged into the combustion chamber 51 is discharged from an outlet 65 into the outside of the fuel pump 10 after passing through areas surrounding the armature 52. A check valve 66 is received by the outlet 65, and prevents fuel discharged from the outlet 65 from flowing backward.

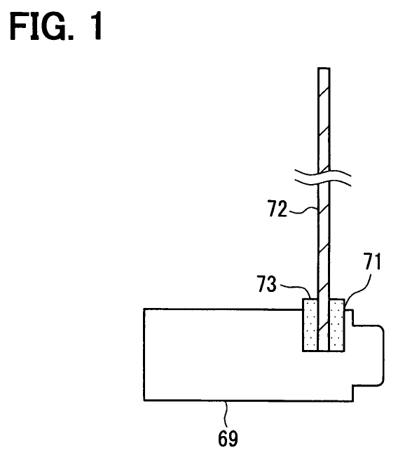

Next, a structure of the brush 69 will be described with reference to FIG. 1.

The brush 69 is electrically connected to the terminal 68 via a pigtail 72. One end of the pigtail 72 is inserted into an attachment hole 71, which is formed on the brush 69. The attachment hole 71 is filled with a metal powder, which constitutes a holding fixture 73 that electrically connects the pigtail 72 and the brush 69. In the housing 11, fuel passes through an area, in which the brush 69 and the commutator 54 are disposed. Accordingly, the pigtail 72 and the holding fixture 73 contact fuel.

A production method of the brush 69 and the holding fixture 73 will be described. The brush 69 is formed to have a predetermined shape by pressure-forming conductive particulates such as carbon to have a shape with the attachment hole 71 and then firing it. The one end of the pigtail 72 is inserted into the attachment hole 71, and the attachment hole 71 is filled with the metal powder to be pressurized. After that, the other end of the pigtail 72 is cut to a necessary length.

The pigtail 72 is made from a copper alloy, and is a stranded wire as a result of stranding constituent wires of the copper alloy. Each constituent wire is approximately 0.1 [mm] in diameter. The copper alloy includes at least a corrosion-resistant metal, which has higher sulfide or oxide formation energy than copper. The oxide formation energy indicates energy needed when a certain element reacts with oxygen to form oxide. As well, the sulfide formation energy indicates energy needed when a certain element reacts with sulfur to form sulfide. The corrosion-resistant metal may be, for example, zinc, nickel, or tin. Zinc, nickel, or tin has higher sulfide formation energy than copper, and higher oxide formation energy than copper, thereby having high resistance to corrosion. The pigtail 72 is under manufacturing control, such that impurities incorporated with the copper alloy are equal to or smaller than 1 wt % as opposed to 100 wt % (percent by mass) of the copper alloy. In addition, “wt %” expresses “percent by mass”, which is prescribed by Japanese Industrial Standards (JIS), and means a ratio of weight of the impurities to weight of an overall copper alloy.

An amount of the corrosion-resistant metal, which is added to the copper alloy of the pigtail 72, is 10 to 50 wt % as opposed to 100 wt % of the copper alloy, and may be 20 to 40 wt % preferably, and approximately 30 wt % more preferably.

A material of the metal powder of the holding fixture 73 is the copper alloy. The copper alloy includes at least the corrosion-resistant metal, which has higher sulfide or oxide formation energy than copper. The corrosion-resistant metal may be, for example, zinc, nickel, or tin. The holding fixture 73 is under manufacturing control, such that impurities incorporated with the copper alloy are equal to or smaller than 1 wt % as opposed to 100 wt % of the copper alloy.

An amount of the corrosion-resistant metal, which is added to the copper alloy of the holding fixture 73, is 10 to 50 wt % as opposed to 100 wt % of the copper alloy, and may be 20 to 40 wt % preferably, and approximately 30 wt % more preferably.

According to the embodiment in which the above structure is employed, the pigtail 72 includes the corrosion-resistant metal, which has higher sulfide or oxide formation energy than copper, so that the resistance to corrosion of the pigtail 72 can be improved. Furthermore, since the pigtail 72 is made from the copper alloy, flexibility of the pigtail 72 can be obtained, compared to when an iron-based metal or carbon fiber is employed for a material of the pigtail 72. Following a movement of the brush 69 in a direction, in which the brush 69 is pressed against the commutator 54 by the coil spring 70, the pigtail 72 can be easily deformed. As a result, damage to the pigtail 72 can be reduced. In addition, the flexibility of the pigtail 72 can be advantageous to fatigue breaking of the pigtail 72, which is caused by vibration of the vehicle or the like.

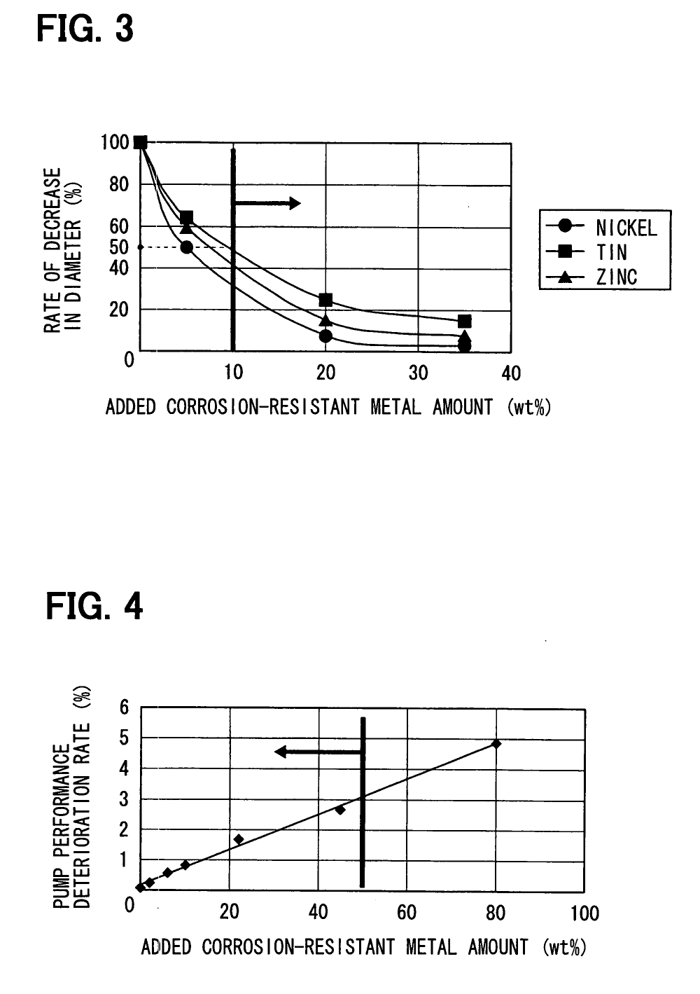

When the amount of the corrosion-resistant metal, which is added to the copper alloys of the pigtail 72 and the holding fixture 73, is excessively small, a sufficient effect of the resistance to corrosion is not produced as shown in FIG. 3. FIG. 3 shows a relationship between a rate of decrease in diameter of the pigtail 72 due to the corrosion and the amount of the corrosion-resistant metal that is added to the copper alloys. Nickel, tin and zinc are indicated as the corrosion-resistant metal. Additionally, the “rate of decrease” is a ratio of a diameter of the pigtail 72 that is corroded, to a diameter of the pigtail 72 that is not corroded.

In the embodiment, since the amount of the corrosion-resistant metal that is added to the copper alloys is equal to or larger than 10 wt %, employment of tin for the corrosion-resistant metal can limit the rate of decrease to equal to or smaller than 50%. Accordingly, breaking of the pigtail 72 can be restricted, and in particular, the fatigue breaking of the pigtail 72 caused by the vibration of the vehicle or the like can be restricted.

On the other hand, when the amount of the corrosion-resistant metal, which is added to the copper alloys of the pigtail 72 and the holding fixture 73, is excessively large, electrical resistance of the pigtail 72 increases, thereby decreasing a voltage of the electricity supplied to the armature 52. As a result, the discharged fuel amount from the fuel pump 10 decreases as shown in FIG. 4. FIG. 4 shows a relationship between a performance deterioration rate of the fuel pump 10 and the amount of the corrosion-resistant metal that is added to the copper alloys. In FIG. 4, tin is employed for the corrosion-resistant metal. Additionally, the “performance deterioration rate” is a ratio of a discharged fuel amount, which is decreased by adding the corrosion-resistant metal, to a discharged fuel amount from the fuel pump 10 when the corrosion-resistant metal is not added.

In the embodiment, because the amount of the corrosion-resistant metal, which is added to the copper alloys is set at a value that is equal to or smaller than 50 wt %, the performance deterioration rate of the fuel pump 10 can be limited to equal to or smaller than 3%.

### Other Embodiments

In order to further increase corrosion resistance of the pigtail 72, a surface of the pigtail 72 may be plated with the corrosion-resistant metal, which has higher sulfide or oxide formation energy than copper.

Although the pigtail 72 of the embodiment is the stranded wire as a result of stranding the constituent wires, it may also be a braided wire.

Although the corrosion-resistant metal, which has higher sulfide or oxide formation energy than copper, is added to both the copper alloys of the pigtail 72 and the holding fixture 73 in the embodiment, the corrosion-resistant metal may be added to at least one of the copper alloys of the pigtail 72 and the holding fixture 73.

Thus, the present invention is not by any means limited to the above embodiment, and it can be embodied in various manners without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A fuel pump comprising:
a pump unit for boosting a pressure of fuel that is drawn into the fuel pump;
a motor unit having an armature that rotates and a commutator that rectifies electric current, which is supplied to the armature, wherein:
the pump unit is driven by rotating of the armature; and
the fuel, the pressure of which is boosted by the pump unit, passes through the motor unit;
a brush that contacts the commutator; and
a pigtail that is connected to the brush and supplies electricity to the armature via the brush, wherein the pigtail is made from a copper alloy, which includes at least one of a corrosion-resistant metal that has higher sulfide formation energy than copper and a corrosion-resistant metal that has higher oxide formation energy than copper.

2. The fuel pump according to claim 1, wherein a ratio of weight of impurities included in the copper alloy of the pigtail to weight of an overall copper alloy is equal to or smaller than 1%.

3. The fuel pump according to claim 1, wherein a ratio of weight of the corrosion-resistant metal included in the copper alloy of the pigtail to weight of an overall copper alloy is 10% to 50%.

4. The fuel pump according to claim 1, wherein the corrosion-resistant metal that is included in the pigtail includes at least one of zinc, nickel, and tin.

5. The fuel pump according to claim 1, wherein:
the brush has an attachment hole, in which one end of the pigtail is inserted; and
the attachment hole is filled with a holding fixture that electrically connects the pigtail and the brush and that is made from a copper alloy powder, which includes at least one of a corrosion-resistant metal that has higher sulfide formation energy than copper and a corrosion-resistant metal that has higher oxide formation energy than copper.

6. The fuel pump according to claim 5, wherein a ratio of weight of impurities included in the copper alloy powder of the holding fixture to weight of an overall copper alloy powder is equal to or smaller than 1%.

7. The fuel pump according to claim 5, wherein a ratio of weight of the corrosion-resistant metal that is included in the copper alloy powder of the holding fixture to weight of an overall copper alloy power is 10% to 50%.

8. The fuel pump according to claim 5, wherein the corrosion-resistant metal that is included in the holding fixture includes at least one of zinc, nickel, and tin.

9. A fuel pump comprising:
a pump unit for boosting a pressure of fuel that is drawn into the fuel pump;
a motor unit having an armature that rotates and a commutator that rectifies electric current, which is supplied to the armature, wherein:
the pump unit is driven by rotating of the armature; and
the fuel, the pressure of which is boosted by the pump unit, passes through the motor unit;
a brush that contacts the commutator and has an attachment hole;
a pigtail that is inserted in the attachment hole and is connected to the brush to supply electricity to the armature via the brush; and
a holding fixture that electrically connects the pigtail and the brush and is made from a copper alloy powder, which includes at least one of a corrosion-resistant metal that has higher sulfide formation energy than copper and a corrosion-resistant metal that has higher oxide formation energy than copper, wherein the attachment hole is filled with the holding fixture.

10. The fuel pump according to claim 9, wherein a ratio of weight of impurities included in the copper alloy powder of the holding fixture to weight of an overall copper alloy powder is equal to or smaller than 1%.

11. The fuel pump according to claim 9, wherein a ratio of weight of the corrosion-resistant metal that is included in the copper alloy powder of the holding fixture to weight of an overall copper alloy power is 10% to 50%.

12. The fuel pump according to claim 9, wherein the corrosion-resistant metal that is included in the holding fixture includes at least one of zinc, nickel, and tin.
